(19) United States
(12) Patent Application Publication
(10) Pub. No.: US 2024/0010287 A1
(43) Pub. Date: Jan. 11, 2024

(54) Detachable Motorcycle Seat-Attached Luggage Rack System

(71) Applicant: Hoang Ba Khoa Nguyen, Ha Noi (VN)

(72) Inventor: Hoang Ba Khoa Nguyen, Ha Noi (VN)

(21) Appl. No.: 17/859,025

(22) Filed: Jul. 7, 2022

(51) Int. Cl. B62J 7/02

(52) U.S. Cl. CPC B62J 7/02

(57) ABSTRACT

This invention relates to the field of detachable motorcycle luggage racks. The luggage rack system comprises two primary assemblies to be placed on two sides of a motorcycle rear seat. The assemblies can be attached to the motorcycle through the upper support, lower support, right support and left support on the primary metal sheet. To lock the latch strikes into place and prevent the assemblies from being stolen, the author uses a lock system that can be unlocked with a key.

To use the invention as a table, two primary metal plates are attached with a double latching system; the double latching system comprises two back plates and two latch bolts. After two primary metal sheets are attached to form a table top, four table legs are connected with the table top through four corner holes on the table top.

### FIELD OF THE INVENTION

This invention relates to the field of multifunctional detachable motorcycle luggage racks. In particular, it describes a system that can be installed on a motorcycle seat, a seat-attached system that can be quickly and easily installed or removed.

### SUMMARY

This invention relates to the field of detachable motorcycle luggage racks. The luggage rack system comprises two primary assemblies to be placed on two sides of a motorcycle's rear seat. These two assemblies comprise symmetrical parts that form a center line on top of the motorcycle's vertical center line. The assemblies can be attached to the motorcycle through the upper support, lower support, right support, and left support on the primary metal sheet. To lock the latch strikes into place and prevent the assemblies from being stolen, the author uses a lock system that can be unlocked with a key.

To use the invention as a table, two primary metal plates are attached with a double latching system; the double latching system comprises two back plates and two latch bolts. After two primary metal sheets are attached to form a tabletop, four table legs are connected with the tabletop through four corner holes on the tabletop.

### STATE OF THE ART

Owners of motorcycles require that their vehicles be versatile. At times, they may wish to carry passengers, at other or at the same times they may need to carry groceries, luggage, or other cargo, and at other times they may wish to restore their vehicle to an appearance of its factory state. There is a market, therefore, for passenger seats and/or luggage racks that can be readily removed from and reattached to the vehicle. Motorcycles further require that the seat or luggage rack attach without damage to the motorcycle, such as would be required were it necessary to drill additional holes in any of the motorcycle components.

It would be advantageous for owners of such motorcycles if the removal of an auxiliary passenger seat and/or luggage rack, or exchange of a seat for a luggage rack or vice versa, were quick, easy, and accomplished without tools. Further, it would be desirable if the seat and/or luggage rack were attached to the motorcycle so that a thief would require tools to remove such from the motorcycle.

A removable auxiliary passenger seat for motorcycles is shown by U.S. Pat. No. 5,322,345, issued to Desser, et al., on 21 Jun. 1994. The seat of Desser attaches to the rear fender of the motorcycle by way of several large suction cups. This seat may be subject to theft because there is no way of locking it to the motorcycle.

An auxiliary child's seat is shown by U.S. Pat. No. 3,746,392, issued to Lorrayne German on 17 Jul. 1973. This seat attaches to an open work metal luggage carrier by way of straps and seat material that deforms into the gaps of the luggage carrier under the occupant's weight.

Additionally, given their inherent compact nature, motorcycles have limited ability to store items during transport. Consequently, various devices have been developed to allow individuals to carry at least a limited number of articles on their motorcycles. The most popular has been the use of carrying devices commonly known as “saddle bags.” Much like the “saddle bags” of the old West, where a cowboy draped two connected leather satchels over the rump of his horse, one form of saddle bag used on motorcycles is also typically suspended over the rear wheel and fender of the motorcycle.

Motorcycle saddle bags are available in three primary types: a soft leather satchel type, a waterproof wear-resistant laminated fabric type, and a hard, suitcase type. As with the saddlebags of Western origin, the soft leather satchel-type bags are simply draped over the rear fender of the motorcycle. The satchels are connected to each other by a leather panel. After the satchels are draped on opposing sides of the motorcycle's rear wheel, they are typically cinched to the rear fender struts of the motorcycle using leather belt straps. The connecting leather panel distributes the load over the motorcycle's rear fender. These soft saddlebags are quickly and easily removed from the motorcycle. Consequently, the motorcycle rider is not forced to continually leave the bags on the motorcycle at all times. As a result, if no need exists to carry anything on the motorcycle, the driver can cruise with minimal wind resistance, increasing the pleasure of the ride.

However, the soft saddlebags have a tendency to move about while the motorcycle is operating. Consequently, the bags may rub against the fender and any adjacent chrome. Additionally, the leather straps used to secure the bags may scratch the paint during installation and in use. Despite their portability, soft saddle bags are more likely to mar a motorcycle's finish.

The alternative saddle bag type, hard case bags, tend to be larger than soft bags, and hence, capable of carrying a greater load. However, given their higher capacity and resulting weight, hard case bags typically have to be permanently installed to ensure that the load is properly distributed and adequately secured to the motorcycle frame. Hence, a motorcycle rider that opts for hard case saddle bags will be likely less able to enjoy an unencumbered streamlined ride, given the considerable time and effort required to remove the bags from the frame of the motorcycle. Additionally, even when the hard case saddle bags are removed, the unsightly residual mounting hardware will also mar the appearance of the motorcycle.

Clow (U.S. Pat. No. 4,096,980) describes a saddle bag mounting bracket which may be adapted to fit a variety of motorcycles. Clow's bracket is complex and does not support simple attachment and release of the saddle bags. With the saddle bags removed from the bracket, an unsightly slotted bar member remains affixed to the motorcycle's frame.

Miller (U.S. Pat. No. D394,632) also describes a saddle bag mounting plate. Although less complex than the bracket described by Clow, this bracket requires permanent installation, is large and obtrusive, and also does not support simple, expeditious bag installation or removal.

Hann (U.S. Pat. No. 5,762,249) describes a motorcycle saddle bag support system for use with throw-over style saddlebags used on HARLEY-DAVIDSON motorcycles. Hann's system is intended to work cooperatively with a motorcycle seat backrest. The primary purpose of this system is to prevent the soft saddlebags from getting caught in the rotating elements of the motorcycle.

Accordingly, a need exists for a motorcycle saddle bag attachment and release system that allows the bags to be quickly and easily installed or removed from the motorcycle. Additionally, a need exists for such a system where the mounting hardware prevents paint or chrome on the motorcycle from being scratched without leaving unsightly hardware on the motorcycle once the saddlebags are removed.

### Technical Nature of the Invention

The purpose of the invention is to create a luggage rack system for saddle bags on both sides of a motorcycle that allows quick installment and removal. The luggage rack system can also be reassembled into a table to serve food and drinks and/or facilitate other entertainment at rest stops.

To achieve the purpose above, the present luggage rack system consists of two assemblies to be placed on two sides of a motorcycle's rear seat.

In one option, the two assemblies comprise symmetrical parts that form a line of symmetry on top of the motorcycle's vertical center line.

The two assemblies comprise two rectangular or square primary metal plates with functional holes to attach units and assemblies and to hang saddle bags and seat bags; These assemblies can be attached to a flat rectangular hang frame installed upright (the upper and lower edges of the hanging frame belong in one vertical plane) or slightly inclined (the upper edge is closer to the center plane of the motorcycle in comparison with the lower edge) placed on two sides of a motorcycle's rear seat. The hanging frame is made from cylinder bars and is connected to a motorcycle's frame with bolts and nuts. In this description, the hanging frame is described as a part of a motorcycle's frame. The primary metal plate has an upper support, a lower support, a right support, and a left support. The lower support has a U-shaped area and the right support and the left support are fixed to the primary metal plate. The upper support comprises a latch strike that is similar to the right and left supports in shape to act as a guide in installing metal plates to a motorcycle's frame. To lock the latch strikes into place and prevent the assemblies from being stolen, the author uses a lock system that can be unlocked with a key. The lock systems and the latch strikes form a structure that firmly fixes the assemblies to the upper part of the hanging frame.

In one option, the hanging frame is inclined. For easier maneuvering around the inclined hang frame, the upper support (including the latch strike and the latch arm) is placed on a height extension detail with a trapezoidal cross-section to keep the metal plate inside a vertical plane when installed to an inclined hang frame.

To use the invention as a table, two primary metal plates are attached with a double latching system; the double latching system comprises two back plates and two latch bolts. After two primary metal sheets are attached to form a tabletop, four table legs are connected with the tabletop through four corner holes on the tabletop.

In one option, when at least one diagonal hang frame 2′ is inclined, at least one height extension detail must be added to one metal plate, so the double system will require at least a pair of height extension bars that has the same level of elevation as the height extension detail to connect two primary metal plates.

In one option, the metal plates are made with additional holes to install extension racks. The extension racks have springs that can latch onto the holes on the metal plates and are manually removable and installable, enhancing the applicability of the primary metal plates: and providing more hanging and strapping capacity.

### BRIEF DESCRIPTION OF THE DRAWINGS

FIG. 1 shows the front of the mounting system;

FIG. 2 shows the back of the invention.

FIG. 3 shows the right-side cross-section of the invention.

FIG. 4 shows an enlarged view of the circled portion from FIG. 3.

FIG. 5 shows the front of the mounting stem with the latch open.

FIG. 6 shows a side cross-section view of the invention released from the frame.

FIG. 7 shows a side cross-section view of the invention positioned into place.

FIG. 8 shows an enlarged view of FIG. 7.

FIG. 9 shows a perspective view of the invention on an inclined hand frame.

FIG. 10 shows a side view of the invention on an included hand frame.

FIG. 11 shows a cross-section of FIG. 10.

FIG. 12 shows an enlarged view of FIG. 11.

FIG. 13 shows a perspective view of an alternate attaching system for the invention.

FIG. 14 shows a back view of the alternate attaching system for the invention.

FIG. 15 shows a side view of the alternate attaching system for the invention.

FIG. 16 shows a cross-section of the alternate attaching system.

FIG. 17 shows a front of the alternate attaching system.

FIG. 18 shows a perspective view of the alternate attaching system with a height extension.

FIG. 19 shows a side view cross-section of the alternate attaching system with a height extension

FIG. 20 shows a side view of the alternate mounting system with a cross-section of the height extension portion and attaching means.

FIG. 21 is a front view of an extension rack.

FIG. 22 is a perspective view of an extension rack.

FIG. 23 is a side view of an extension rack

FIG. 24 shows the extension racks in place.

FIG. 25 shows a side view of the latch.

FIG. 26 shows a perspective view of the latch.

FIG. 27 shows a back view of the latch.

FIG. 28 shows a front view of the latch.

FIG. 29 shows a top view of two primary plates connected in table assembly.

FIG. 30 shows the bottom view of two primary plates connected in table assembly.

FIG. 31 shows a front projection of the fully assembled table option.

FIG. 32 shows a side view of the fully assembled table option.

FIG. 33 shows a front projection of the fully assembled table option in an alternate option.

FIG. 34 shows a side view of the alternate table opinion.

### DETAILED DESCRIPTION OF THE INVENTION

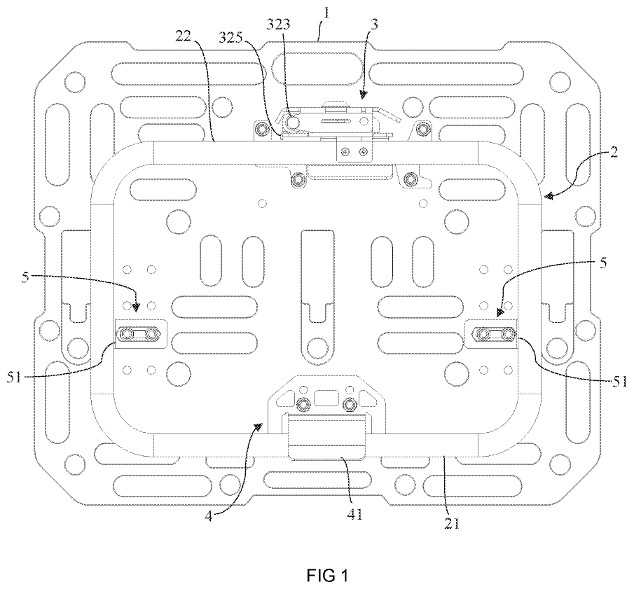

As shown in FIG. 1-4, the present mounting system includes a primary metal plate 1 thread-fixed to a flat rectangular hang frame through the lower support 4, upper support 3, and right and left supports 5 on the metal plate. The lower support has part 41 that together with the metal plate forms an inverted U-shape; the inverted U shape has dimensions that can fit the outside diameter of the flat hang frame 2; the hollow part of the inverted U shape is padded with a rubber or plastic piece 42.

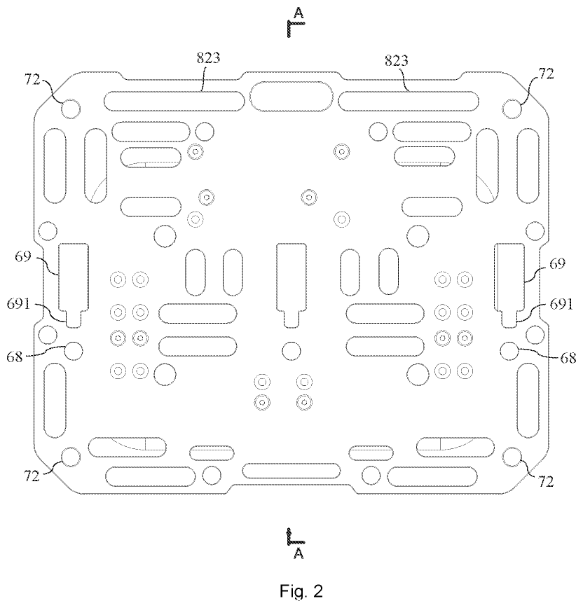

The primary metal plate 1 is rectangular and has threaded holes for threaded joints with the upper, lower, right, and left supports (3, 4, 5); corner through holes 72 to attach table legs 7; through holes 69 with adjacent fin 691 to attach to a latch 62 of an extension rack 6, in which during use (the primary metal plate sitting vertically to the motorcycle) fin 691 sit below through hole 69, while operational hole 68 sits below fin 691. The primary metal plate also has additional through holes to reduce weight and facilitate handling, hanging, and strapping (FIG. 2).

The right and left supports have rack bumper 51 on bases 5, basically at right angles to the primary metal plate 1 and touching the inner edges of the vertical bars of the flat hang frame 2 to guide and position the primary metal plate 1 as it attaches to the hanging frame 2.

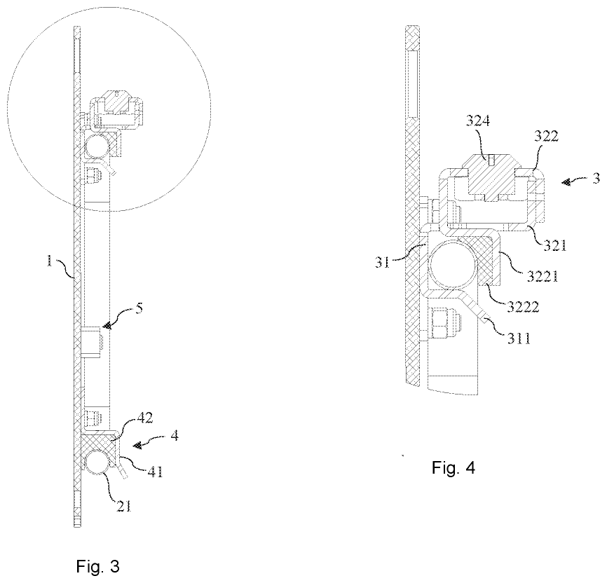

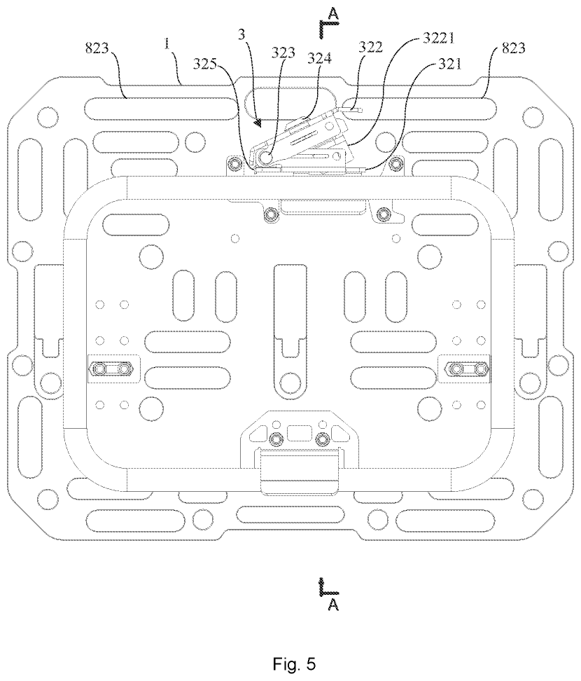

The upper support 3 comprises two parts (FIGS. 3 and 4): a strike 31 and an arm 32. Strike 31 has a support piece 311 basically at a right angle to the primary metal plate 1 and leaning on the inner edge of the horizontal upper bar of the flat hang frame 2 to guide and position the primary metal plate 1 as it attaches to the hang frame 2. The latch 3 is fixed to the primary metal plate 1, in which its static part 321 is firmly fixed to the primary metal plate 1 and its dynamic part 322 can rotate around peg 322, which is perpendicularly fixed to the primary metal plate 1 and the static part 321; there is a latch mechanism 324 to keep the static part and the dynamic part locked together. The static part 321 and the dynamic part 322 are also mutually driven with spring 325 which pulls the dynamic part towards the static part to form a normally closed latch that can be manually opened. The dynamic part 322 has a latch plate 3221 and a rubber or plastic padding 3222 inside the latch plate 3221, leaning on the horizontal upper bar 22 of the flat hang frame 2 to allow smoother removal and installation and firmer fixing to the flat hang frame 2. In the locked state, the upper side of the support piece 311, the base of the strike 31 and the latch plate 3221 (padding 3222) form a U shape-holding in place the horizontal upper bar 22 of the flat hang frame 2 and fixing the primary metal plate 1 to the frame 2.

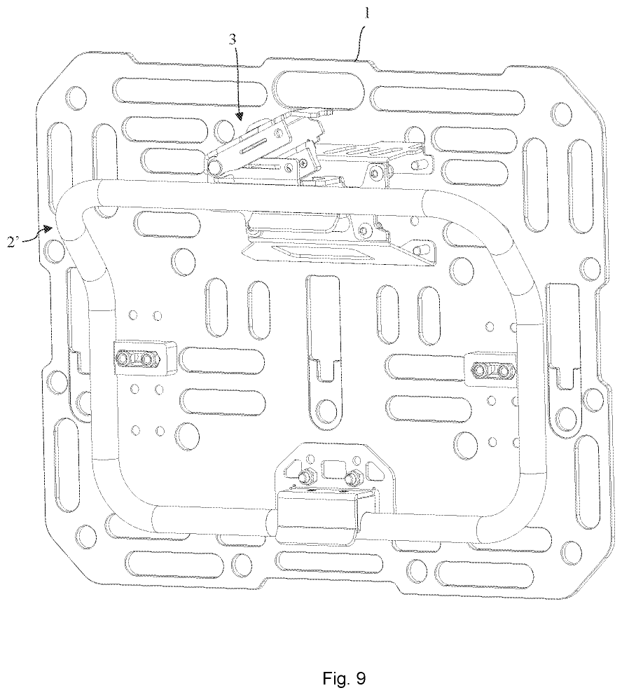

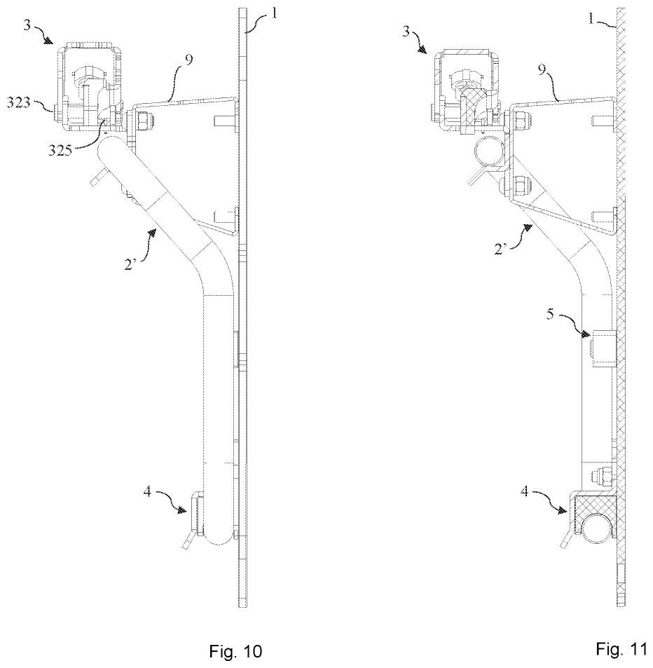

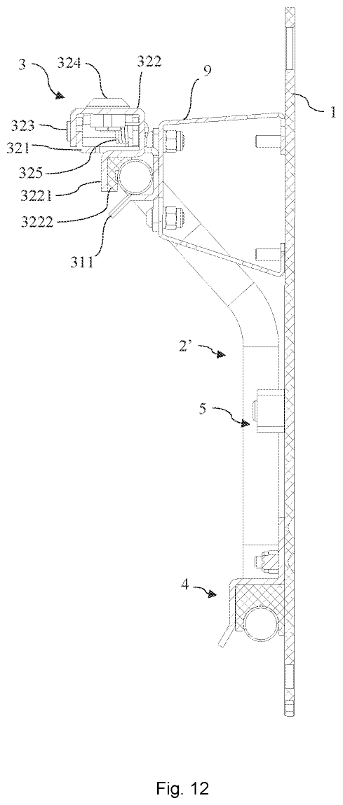

In one option (FIG. 9-12), when at least one diagonal hang frame 2′ is inclined as shown in FIG. 3, the horizontal lower bar and the two vertical bars sit vertically to the motorcycle, while the horizontal upper bar is inclined towards the motorcycle frame. In this option, to fix the primary metal plate to the diagonal hang frame 2′, the upper support 3 is supported with the height extension box 9 with a trapezoidal cross-section, a top piece that fits the base of the upper support 3, a bottom piece fixed to the primary metal plate 1 with threaded joints.

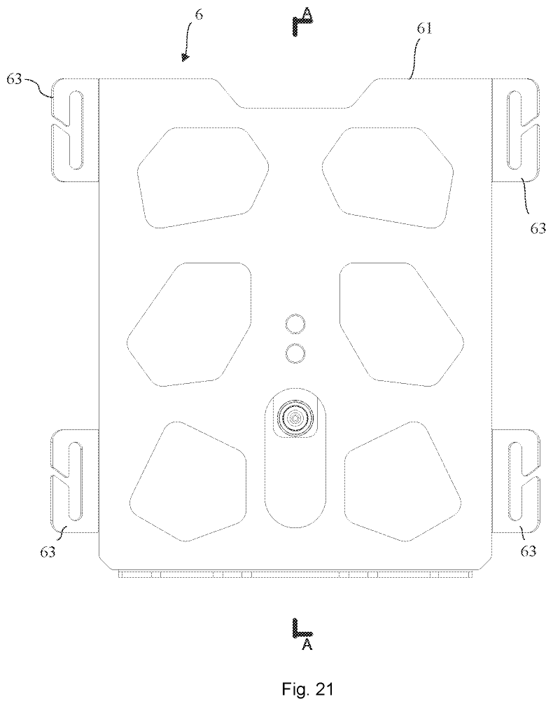

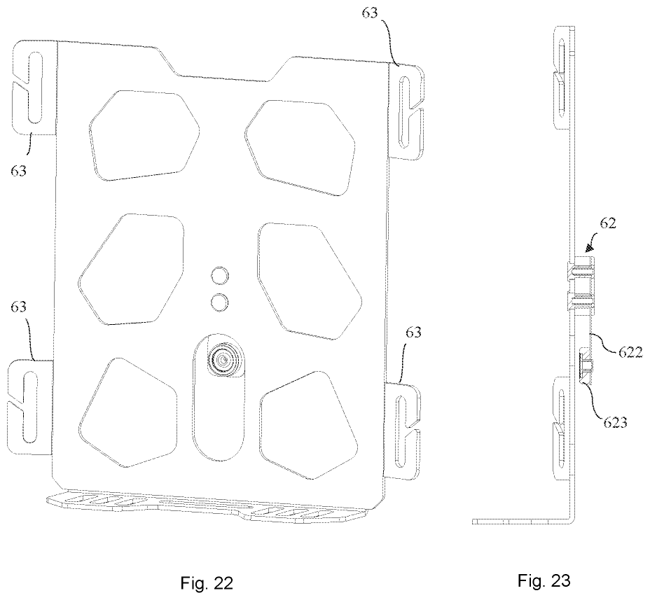

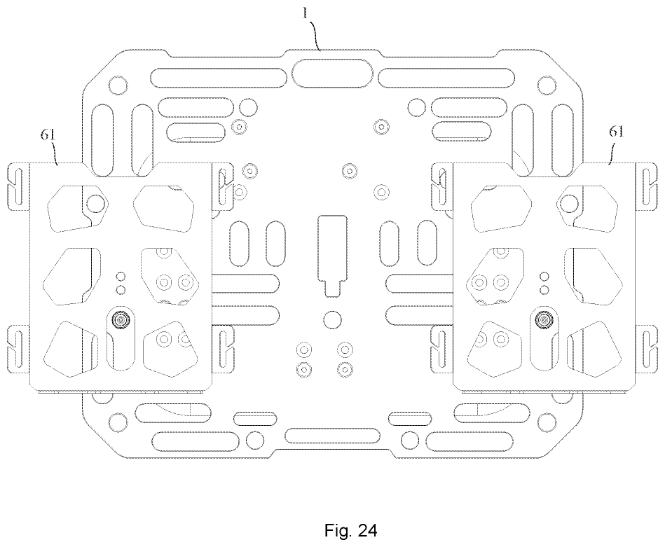

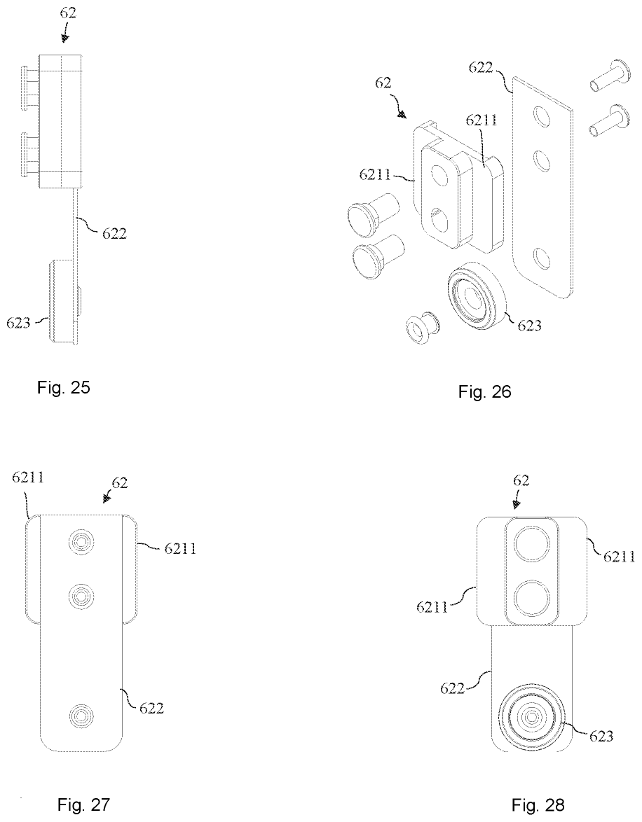

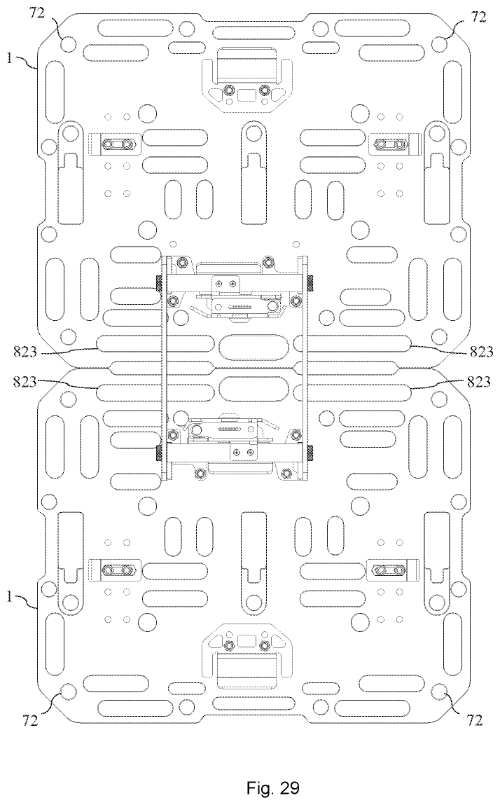

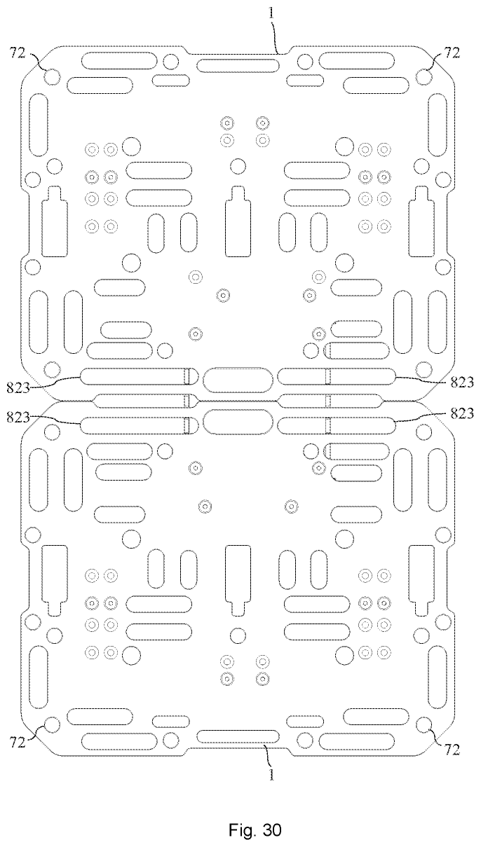

In one option, the primary metal plate 1 has holes 69 to attach extension racks 6. The Extension rack 6 has a rectangular extension plate 61 with rack ears 63 for hanging bags and other items. Extension rack 6 can attach to the primary metal plate 1 through a latch 62 at the relative center of extension rack 6. The latch 62 is fixed to the extension rack 6 with rivet heads. The latch 62 comprises a slider 621 with fins 6211 on both sides that can slide into sliding tracks of fin 691 of hole 69; a leaf spring 622 with one end attaching to the slider 621 and the other end fastened to lug 622 with a rivet head. The shape and dimensions of latch 62 fit the shape and dimensions of hole 69 and fin 691 so that when latched together the whole latch 62 can go through hole 69 (the leaf spring through fin 691). When latched, lug 622 sits inside operational/positioning hole 68 on the primary metal plate to prevent rack 6 from loosening during use (FIG. 21-24 and FIG. 25-28).

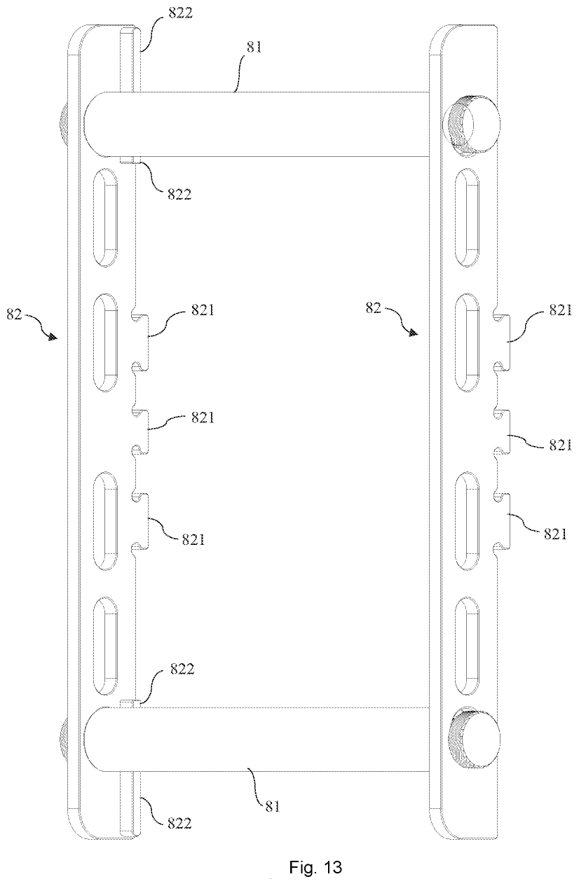

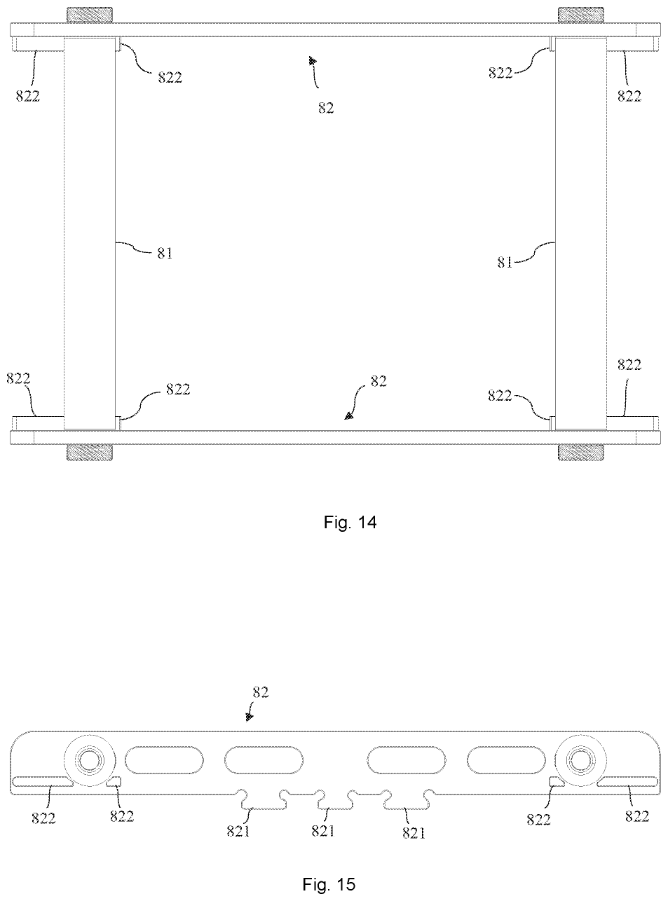

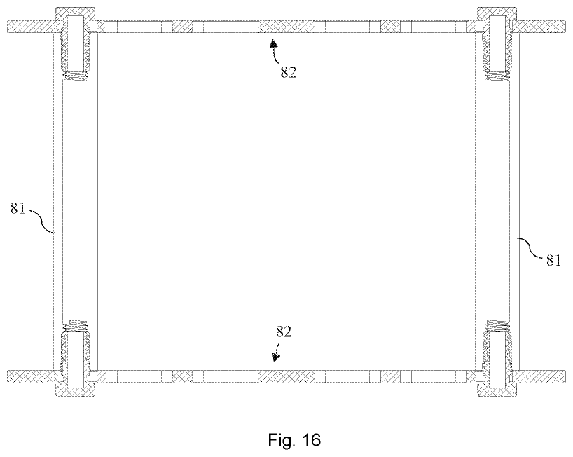

To use the present invention as a table, two primary metal plates are attached with a latching system 8 (FIG. 13-16). The latching system 8 includes two main bars 81 with an outside diameter equal to the diameter of the bars of the flat hang frame 2 so that they can fit in the U-shape detail of the upper support 3, two connecting bars 82 to connect the two main bars 81 at a predetermined distance so that when latched together, the edges of the two primary metal plates 1 touch each other and create a tabletop. Details 81 and 82 are fixed to one another with threaded joints. When latched, the connecting bars 82 touch the inner plane (bottom plane) of the primary metal plates 1, teeth 821 on the connecting bars 82 connect with long oval holes 823 on the primary metal plates 1 to support and keep the primary metal plates 1 firmly connected and unshifting.

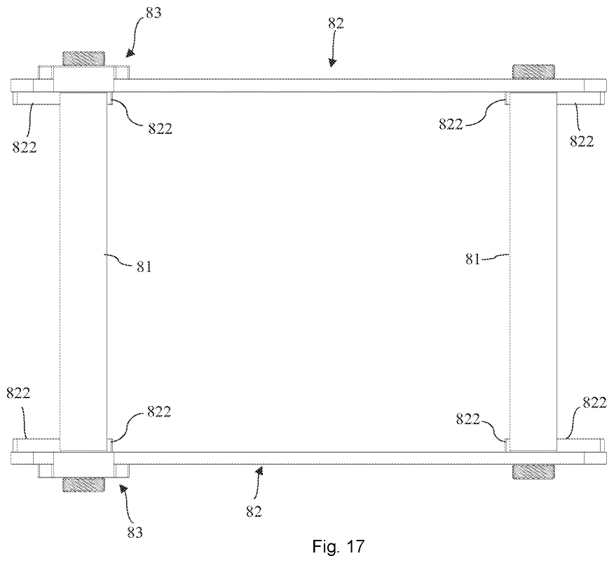

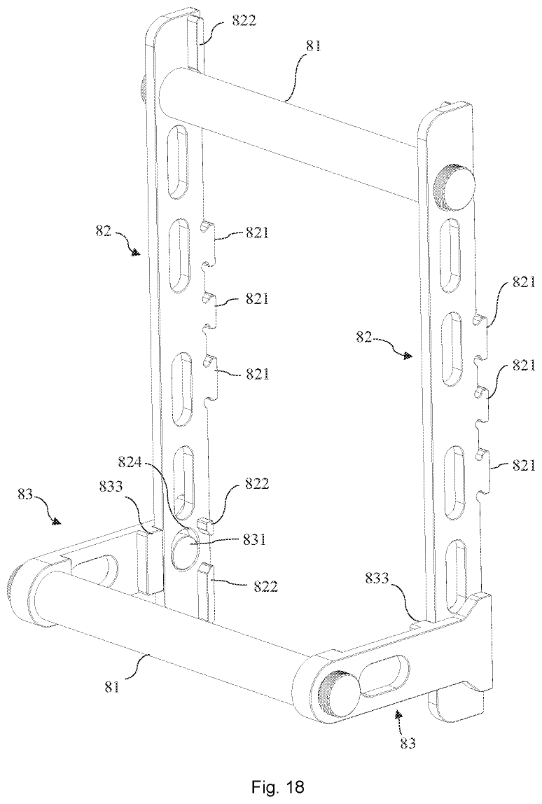

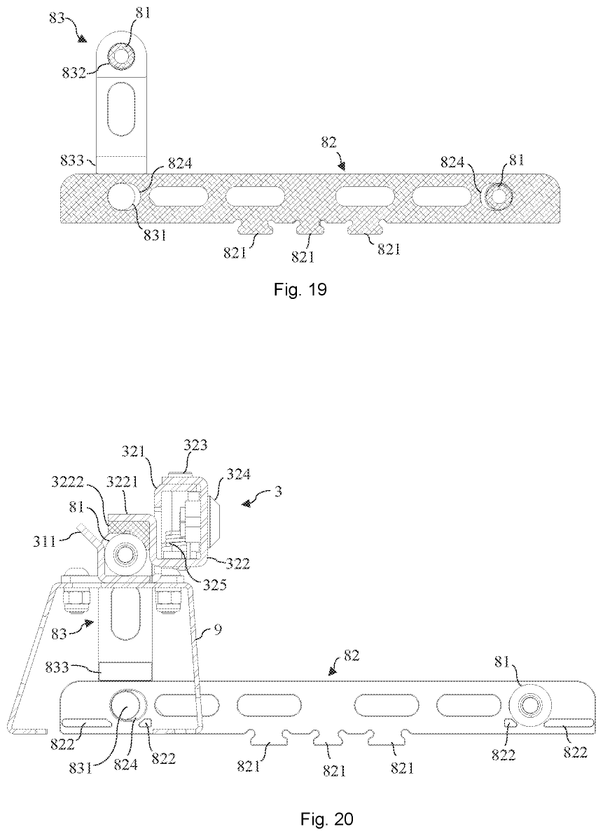

In one option, when at least one diagonal hang frame 2′ is inclined, a height extension box 9 is used to support the upper support 3 (FIG. 17). In this option, the latching system 8 also requires at least a pair of height extension bars 83 to connect the main bars 81 and the connecting bars 82. The height extension bars 83 have ring lugs 831 for connection with holes 824 on the connecting bars 82 and eyes 832 for connection with the main bars 81; additionally, for enhanced strength, lugs 833 on the height extension bars 83 and lugs 822 on the connecting bars 82 help keep the details firmly together and unshifting.

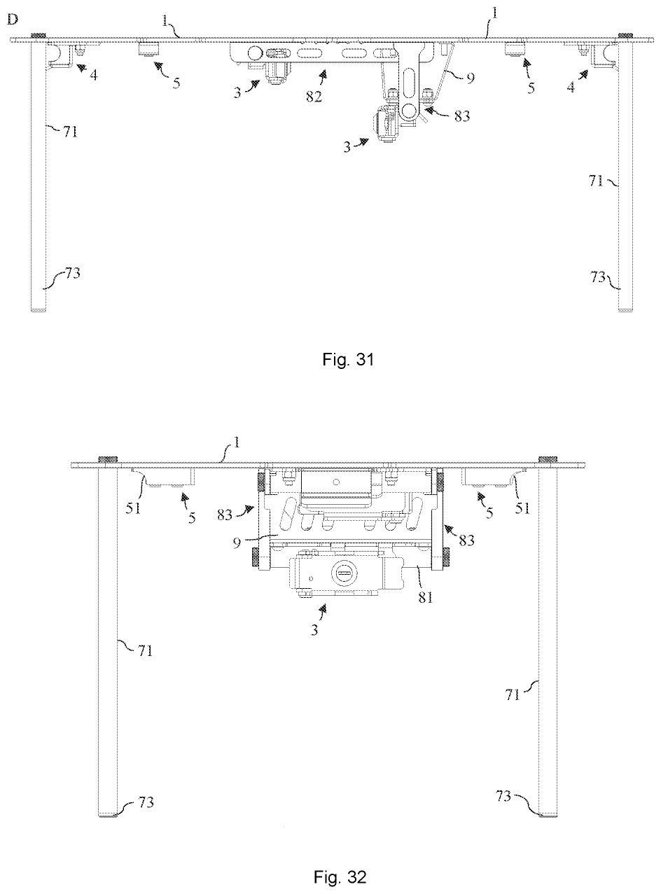

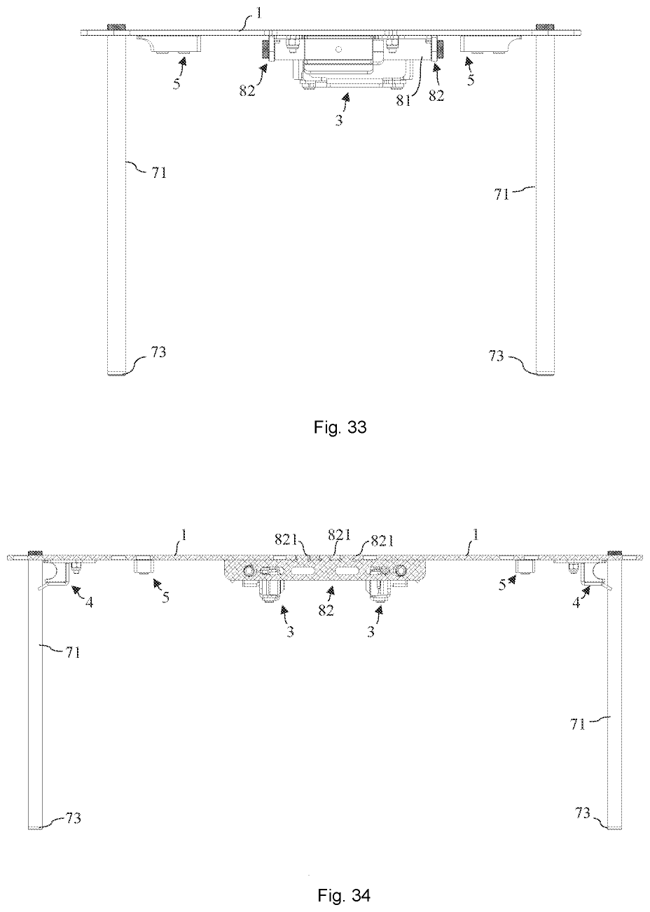

The table legs 7 with cylinder bodies 71 are made to connect through holes 72 on primary metal plates with threaded joints; the lower end of a table leg has a rubber or plastic glide 73 to provide easier use (FIG. 31-32 and FIG. 33-34).

Installation and Use:

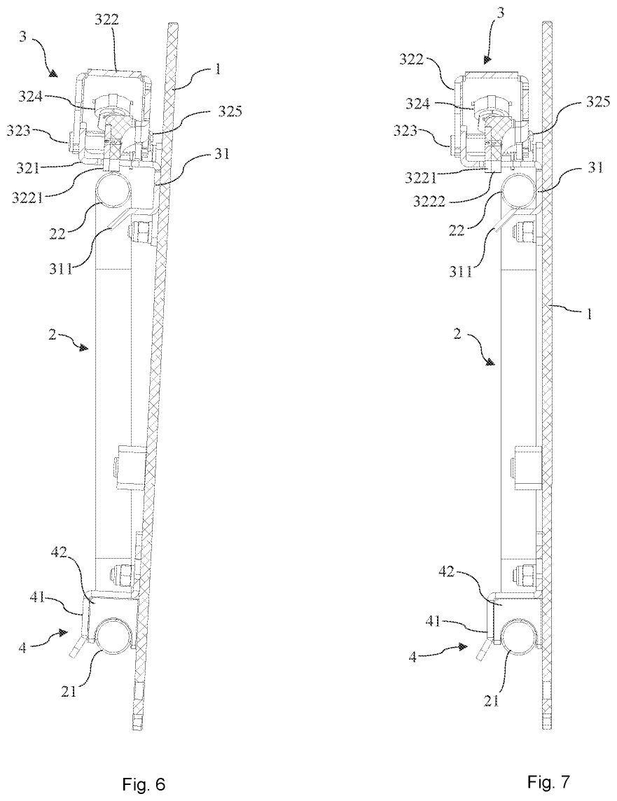

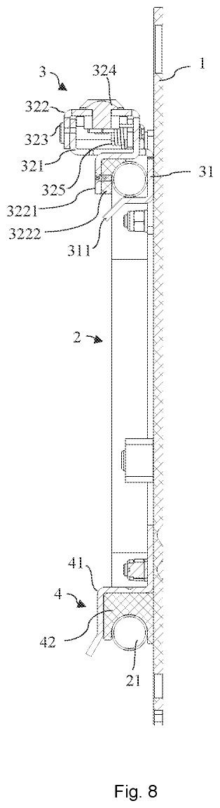

When in use, the upper, lower, right, and left supports (3, 4, 5) connect to the primary metal plate 1 with threaded joints. The following steps should be followed in the installation:
Place the inside surface of the inverted U shape formed by part 41 of the lower support onto the horizontal lower bar 21 of the flat hang frame 2 so that the padding 42 touches the upper edge of the horizontal lower bar 21;
Open the lock 324, lift and rotate the dynamic part 322 upwards around the end fixed in place with peg 322, and push the upper part of the primary metal plate towards the flat hang frame 2 so that the upper support piece 311, the left and right rack bumpers 51 touch the inner edge of the flat hang frame 2, glide into the inner area the flat hang frame 2 to position the primary metal plate as it attaches the flat hang frame 2;
After the primary metal plate 1 has been placed firmly into and against the flat hang frame 2, release the dynamic part 322. Thanks to spring 325, the dynamic part 322 returns to the horizontal position, leaning on the static part 321, pulling the latch plate 3221 and the padding 3222 down to lean on the inner edge of the horizontal upper bar 22, forming a closed box shape fixing the primary metal plate to the frame 2 (FIG. 6 and FIG. 7);
Follow the reverse order to remove the primary metal plate from the flat hang frame 2.
To install an extension rack 6, fit latch 62 through hole 69 and track fins 691, then push extension rack 6, along with latch 62, downwards in a gliding motion until slider 621 is stopped by the lower edge of hole 69. Lug 622 will be sitting inside the operational hole 68;
To remove an extension rack 6, put one finger through operational hole 68 and push lug 622 inwards and away from operational hole 68, at the same time with the other hand slightly slap the bottom of the extension rack 6 to make it go upwards, then lift the extension rack 6 off hole 69 and track fin 691 in reverse order (compared to installation).

To use the present invention as a table, first of all, place two primary metal plates edge to edge on a flat platform so that two upper supports 3 sit closely to each other;
Open lock 324 to lift and rotate the dynamic part 322 around peg 322;
Place the main bars 81 into the inside of the U shape of the upper support 3;
   Release the dynamic part 322. Spring 325 will pull the dynamic part 322 to a horizontal position, leaning on the static part 321, pulling the latch plate 3221 and the padding 3222 down to lean on the edge of main bars 81, forming a closed box shape keeping main bars 81 in place;
   Fix connecting bars 82 so that teeth 821 connect with long oval holes 823 on the primary metal plates;
Connect the connecting bars 82 with the ends of the main bars 81 with threaded joints; Installed table legs 7 through holes 72 on the primary metal plates 1 with threaded joints; turn the result upside down and we have a table assembled from two primary metal plates 1;
Follow the reverse order to remove the table.

When at least one diagonal hang frame 2′ is inclined in one option, a height extension box 9 is used to support the upper support 3. In this option, the latching system 8 also requires at least a pair of height extension bars 83 to connect the main bars 81 and the connecting bars 82. The height extension bars 83 have ring lugs 831 for connection with holes 824 on the connecting bars 82 and eyes 832 for connection with the main bars 81; additionally, for enhanced strength, lugs 833 on the height extension bars 83 and lugs 822 on the connecting bars 82 help keep the details firmly together and unshifting.

I claim:

1. (canceled)

2. (canceled)

3. (canceled)

4. A detachable motorcycle seat-attached luggage rack system that attaches to a motorcycle's hang frame comprising;
a primary plate with a lower support, an upper support, and right and left supports, attached to the plate through attaching means, and;
the lower support in conjunction with the primary plate forms an inverted u-shape;
with the inside part of the inverted u-shape padded with a flexible material.

5. A luggage rack system as in claim 4 where the upper support comprises a hand releasable clasp.

6. A luggage rack system as in claim 4 where the right and left supports are comprised of flexible material that attaches to the hanging frame with pressure.

7. A motorcycle luggage rack comprising a primary plate, that attaches to the side of the motorcycle and can be detached from the motorcycle, and legs that can attach to the primary plate through attaching means allowing the plate to function as a table.

8. A motorcycle luggage rack as in claim 7 further comprises a second primary plate that is attachable to the first primary plate and the legs are then attached to the bottom of both plates to form a table.
